(19) United States
(12) Patent Application Publication
(10) Pub. No.: US 2006/0201041 A1
(43) Pub. Date: Sep. 14, 2006

(54) Sticker comprising a metallisation layer protected against corrosion

(75) Inventors: Werner Ehrmann, Meerane (DE); Uwe Baier, Glauchau (DE); Klaus Brandenburg, Holzkirchen (DE); Stefan Demmel, Abensberg (DE); Mathias Ehrich, Swenleau (DE); Steffen Schneider, Breitenau (DE); Wolfgang Zollner, Holzuirchen (DE)

Correspondence Address: ROTHWELL, FIGG, ERNST & MANBECK, P.C., 1425 K STREET, N.W., SUITE 800, WASHINGTON, DC, 20005, US

(73) Assignee: CCL BATTERY LABEL GMBH, Meerane (DE)

(21) Appl. No.: 10/553,194

(22) PCT Filed: Apr. 16, 2004
(86) PCT No.: PCT/EP04/04070

§ 371 Date: Oct. 13, 2005

(30) Foreign Application Priority Data
Apr. 16, 2003 (DE) 103 17 577.6

(51) Int. Cl. G09F 3/10; B32B 9/04

(52) U.S. Cl. 40/675; 428/411.1

(57) ABSTRACT

In order to reduce corrosion damage in the marginal edge region of a label, as can occur in particular in the case of metallized battery labels in an environment with high atmospheric humidity, it is proposed that, at or close to at least one portion of the peripheral edge (35) of the film layer (23) defining the label contour, the marginal edge (37) of a metallization layer (31) provided between a transparent plastic film layer (23) and a further covering layer (25) be sealed off by a sealing strip (41).

The invention relates to a label with a metallization layer protected against corrosion, in particular for encasing a dry battery.

In a large number of applications, labels, such as adhesive labels, are intended to have a metallically glossy printed image. This applies in particular but not exclusively to labels intended for encasing dry batteries, since the purchasers of such dry batteries associate special ideas of quality with their metallically glossy exteriors. Metallically glossy printed images can be achieved with special printing inks containing metal particles, but such printing techniques do not always meet the desired requirements. Sufficiently metallically glossy printed images can be achieved if the printing inks are underlain with a metallization layer vapor deposited or sputtered or laminated on. Such metallization layers, in particular when they consist of aluminum because of the costs, can be corroded by environmental influences or else substances of other label layers or of the object to which the label is stuck, and have to be protected if the label is not intended to change its appearance in use.

For example, in the case of labels intended to encase the body of a dry battery, it is known from U.S. Pat. No. 4,801,514 or U.S. Pat. No. 6,248,427 to accommodate the metallization layer, if appropriate together with further layers, for example a printing ink layer forming a decorative imprint, between two protective layers of the layer composite of the label. These protective layers, of which at least one is formed as a plastic film layer, protect the flat sides of the metallization layer against corrosive substances, in particular electrolyte residues which may possibly remain on the body of the battery.

In particular in the case of battery labels of the above type, it has been shown that high atmospheric humidity, such as prevails in tropical countries, for example, accelerates the corrosion of the metallization layers to a great extent. In particular, the corrosive action also takes place from the marginal edges of the metallization layer as a result of the capillary forces which, for example in the case of battery labels on the outside of the body of the battery, draw remaining, moist electrolyte residues into the layer composite of the label, which is detached because of the corrosion.

It is an object of the invention to protect the metallization layer of a label, in particular an adhesive label intended to encase the body of a dry battery, to an increased extent against corrosion.

The invention is based on a label which comprises:

a transparent plastic film layer, a covering layer covering the film layer flatly and a metallization layer arranged between the film layer and the covering layer and covering the latter flatly and completely on both its flat sides.

According to the invention, the corrosion resistance of such a label is improved in that the metallization layer, at or close to at least one portion of the peripheral edge of the film layer defining the label contour, has a layer edge which is covered by a sealing strip extending at least over the thickness of the metallization layer. The sealing strip protects the layer edge, which is exposed in conventional labels of this type, against the action of corrosive substances and therefore prevents the separation from the metallization layer of the layers adjacent to the metallization layer.

The layer composite of a label of the type explained above does not necessarily have to comprise an adhesive layer, for example in the form of a contact adhesive layer or a hot-melt adhesive layer or an adhesive layer that can be activated by heat or the like to be affixed to an object. The adhesive layer can be applied subsequently to the label or else to the object during the affixing of the label. However, a label according to the invention should also be understood to mean hangers or the like formed as a layer composite, which can be used independently of an object or connected to the object in any other way by means of a connecting tape or the like. The invention is not restricted to use in dry batteries. For instance, labels of the type according to the invention can also be employed in the case of containers, such as bottles or the like.

In the layer composite, the metallization layer lies protected between the transparent plastic film layer and the covering layer. These two layers cover the flat sides of the metallization layer and form barriers against the ingress of corrosive substances to the flat sides of the metallization layer. The film layer and/or the covering layer can in this case rest directly on the metallization layer; however, further layers of the layer composite can also be arranged between the metallization layer and the film layer or the metallization layer and the covering layer. These further layers can be, for example, a printing ink layer forming the decorative imprint between the transparent film layer and the metallization layer. However, connecting layers required for the construction of the layer composite, such as laminating varnish or laminating adhesive layers, can also be provided.

The covering layer can be an adhesive layer used to affix the label to the object, for example a pressure-sensitive contact adhesive layer or else a hot-melt adhesive layer or an adhesive layer that can be activated by supplying energy, for example heat. The covering layer can be a barrier layer produced, for example, by a printing technique. In particular if the layer composite additionally comprises an adhesive layer used for application to the object, it can be expedient to provide such a barrier layer between the metallization layer and the adhesive layer for forming the covering layer, in order to prevent the migration of corrosive substances from the side of the adhesive layer.

In a preferred embodiment, the covering layer is not produced by a printing technique but is likewise formed as a plastic film layer, as explained in U.S. Pat. No. 4,801,514, for example. In addition, the second film layer can consist of a transparent plastic. If appropriate, more than two plastic film layers can also be provided in the layer composite. In a manner known per se, the individual film layers can form the production substrates for the application of the printing ink layer forming the decorative imprint on the metallization layer or, if appropriate, the adhesive layer and can be brought together by means of connecting layers of the type explained above, such as the laminating adhesive layers or the like, in the course of the production process of the label.

The sealing strip can be implemented in an extremely wide range of ways. It is important that the sealing strip along the layer edge of the metallization has a continuous strip structure free of metallization material. However, in an individual case, the strip structure can contain inclusions of metallization material, for example metallization particles, provided that the gaps between the particles and the metallization layer to be protected by the sealing material are filled in the form of a strip running in a closed manner along the layer edge of the metallization layer.

In a first preferred variant, provision can be made for the marginal edge of the metallization layer to run along the sealing strip at a distance from the peripheral edge of the two film layers mentioned above, and for a connecting layer to be arranged between the two film layers, extending beyond the marginal edge of the metallization layer and forming the sealing strip. The two film layers therefore extend beyond the marginal edge of the metallization layer and are connected to each other outside the metallization layer, for example by means of a laminating adhesive layer or else by means of a laminating varnish layer or a contact adhesive layer. The methods by which the metallization-free region along the film layer forming the substrate of the metallization layer is produced can be different. Firstly, the metallization layer can be cut out as early as during application to the substrate, for example by means of vapor deposition or sputtering on in suitable transfer processes, such as in the case of applying the metallization by means of cold or hot embossing. However, the cutout from the metallization layer can also be produced subsequently in a metallization layer initially applied to the entire area of the substrate, for example by the metallization layer being removed partially by means of mechanical methods, such as grinding off or pressure jet methods with liquids or with abrasive particles. Methods with adhesive tapes which lift the metallization layer off its substrate are also suitable.

In a second preferred variant, provision can be made for the layer composite to comprise, on the side of the metallization layer facing away from the transparent film layer mentioned at the beginning, an adhesive layer used to affix the label to an object, the marginal edge of the metallization layer and the marginal edge of each further layer arranged between the metallization layer and the adhesive layer in the layer structure, in particular of a second film layer, running at a distance from the peripheral edge of the first-named film layer, and for the adhesive layer to extend beyond the marginal edge of the metallization layer and, if appropriate, further layer and to form the sealing strip. In this configuration, the metallization layer and at least the layers of the label located between the metallization layer and the adhesive layer are shorter, as referred to the peripheral contour of the outermost film layer, and are sealed off by the adhesive layer with respect to the projecting peripheral region of the outer film layer. In the production process of this label, the mutually offset peripheral contours of the two film layers are produced by two successive punching steps.

In a third variant, provision can be made for a connecting layer, for example a laminating adhesive layer or a laminating varnish layer or contact adhesive layer, to be arranged between the two film layers, extending beyond the marginal edges both of the metallization layer and of the two film layers and reaching over the marginal edges of the two film layers in order to form the sealing strip. As opposed to the second variant, the peripheral contour of the label can be defined by a single punching step. The excess of the connecting layer material forming the sealing strip can, however, be applied subsequently to the edge of the peripheral contour, but is preferably forced out of the layer composite by squeezing the label composite in the marginal region.

In the variants explained above, the sealing strip extends outside the peripheral contour of the metallization layer and is applied to at least one of the two film layers. In a fourth prefer-red variant, provision is made for the metallization layer to have, at a distance from the peripheral edge defining the label contour, a gap which forms the layer edge and which is filled with the sealing strip. In this variant, therefore, the metallization layer extends somewhat beyond the marginal region protected by the sealing strip. In this variant, although it is accepted that a negligibly narrow marginal strip of the metallization layer can also remain subjected to corrosion, this visual disadvantage, which is not serious in practice, is balanced out by the advantage of the simplified production of the label. The gap can be a punch cut possibly displacing material, such as may be carried out without difficulty and with little effort in continuous label production methods. It is advantageous in particular that the course of the gap contour can be configured as desired without great effort. In particular, gaps following the entire peripheral contour of the label and possibly of closed-circle shape for accommodating the sealing strip can also be produced very simply. It is also advantageous that the sealing strip can be part of a layer to be provided in the layer composite in any case, that is to say, for example, part of a printing ink layer or a connecting layer such as a laminating adhesive layer or a laminating varnish layer or the adhesive layer intended to affix the label to the object. Since the layer thickness of the metallization layer is generally extremely small, it does not require any special measures to fill the gap with the layer material normally applied in a printing process.

In principle, it is sufficient if the gap merely penetrates the metallization layer. However, in the case of a label comprising at least two plastic film layers, the production process can be configured in a variable manner and simplified if the gap not only penetrates the metallization layer but also extends at least partly into one of the two and preferably completely through this one film layer. The gap expediently extends through a film layer on the inside in the layer structure of the label.

Although the gap intended to accommodate the material of the sealing strip or a gap-like interstice adjoining the layer edge of the metallization layer may be produced very simply by means of a punching step, other methods for the production of such gaps or interstices can also be employed. For example, by means of suitable control of the metallization operation, care can be taken that, in the region of the gap or of the interstice, a large number of non-cohering, very small regions of the metallization layer are formed, with the result that these “metallization particles” are embedded all around completely in the material of the sealing strip. The gap or the interstice for the sealing strip can, however, also be engraved into the metallization layer or produced by removing the metallization layer by means of microwave energy or corona discharge. However, the metallization layer for the gap can also be produced by a high-pressure jet treatment with a fluid or a solid particle jet or by means of brushing off or by means of etching.

The label is preferably a battery label intended to encase the peripheral surface of a substantially cylindrical body of a dry battery and capable of being shrunk with its edges projecting axially beyond the body of the dry battery onto the end surfaces of the latter, such as described, for example, in U.S. Pat. No. 4,801,514 or U.S. Pat. No. 6,248,427. The body of such a dry battery has a cylindrical housing cup which is filled with electrolyte, consists of metal and forms one of the two poles of the dry battery. The other pole of the dry battery is formed by an end cover which is inserted in an electrically insulated manner into the cup and against whose edge the opening edge of the housing cup is flanged over. The housing cup contains an electrolyte, for example KOH, of which, from the production process of the battery, many residues are found on the outside of the cup, in particular in the region of the flanged-over portion. Here, in particular, the battery label is subjected to corrosion by electrolyte residues to a particularly severe extent, so that the metallization layer of the battery label is preferably sealed off with a sealing strip at least along the edge of the battery label shrunk on to the end surface forming the flanged-over portion. In configurations in which the metallization layer for accommodating the sealing strip is cut out in a strip shape, provision is preferably made for the cutout to extend in a strip shape in the longitudinal direction of the film web. The film layers of the battery label, in order to be capable of shrinking back when heated, have to be stretched in their longitudinal direction, it being necessary to choose the position of the labels relative to the film longitudinal direction such that such position coincides with the subsequent peripheral direction of the battery body. The strip-shaped region to be cut out of the sealing strip, possibly in the metallization layer, can in this way likewise lie in the longitudinal direction of the film web, which makes it easier to produce the strip-like cutout of the metallization layer.

In the following text, exemplary embodiments of the invention will be explained in more detail using a drawing. Here:

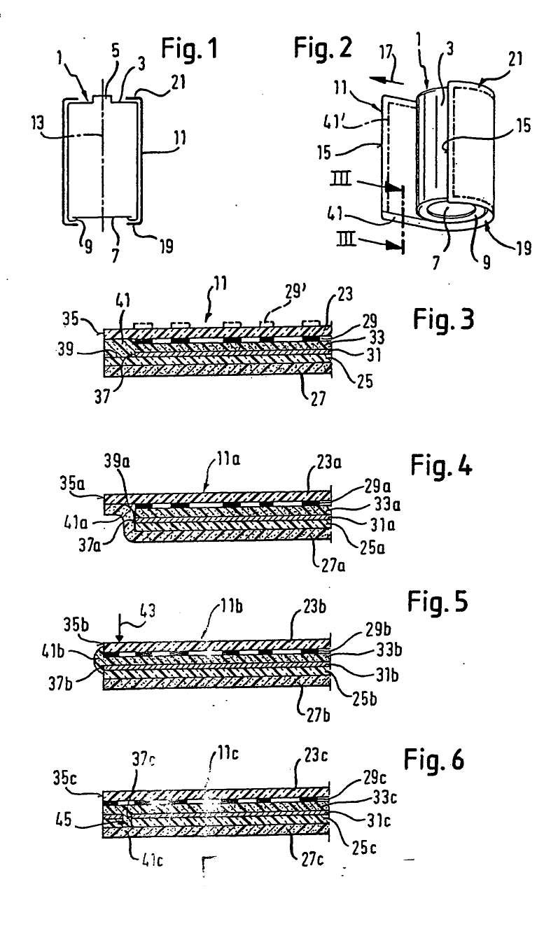

FIG. 1 shows a schematic longitudinal section through a dry battery having a battery label according to the invention;

FIG. 2 shows a perspective illustration of the dry battery during the affixing of the battery label;

FIG. 3 shows a detailed view through the battery label, viewed along a line III-III in FIG. 2;

FIGS. 4 to 6 show partial views through variants of the battery label in a sectional view similar to FIG. 3.

FIGS. 1 and 2 show in schematic form a substantially cylindrical battery body 1 of an alkali dry battery. The battery body 1 is delimited by a housing cup 3 consisting of metal, for example steel, whose base at the end is provided with a contact projection 5 forming the positive pole of the battery. The other end of the battery body 1 is delimited by a metal cover 7 forming the negative pole of the battery, which metal cover 7 closes the opening of the housing cup 3 and is fixed in an electrically insulated manner by a flanged-over portion 9 of the opening edge of the housing cup 3. The insulation, not specifically illustrated, between the metal cover 7 and the flanged-over portion 9 seals off the battery electrolyte, KOH here, contained in the housing cup 3 from the outside.

Adhesively bonded to the entire area of the periphery of the battery body 1 is a substantially rectangular contact adhesive label 11, whose edges 15 running parallel to the cylinder axis 13 of the battery body 1 overlap in the peripheral direction of the battery body 1 when the label is stuck on. As is explained, for example, in U.S. Pat. No. 4,801,514 or U.S. Pat. No. 6,248,427, the battery label 11 is produced as a layer composite having at least one plastic film layer which, in the course of the production process, has been stretched, at least in one direction, such that the film layer shrinks back when heated. The stretching direction, as shown by an arrow 17 in FIG. 2, runs in the peripheral direction of the battery body 1 when the label is affixed. The battery label 11 projects beyond the battery body 1 in the axial direction of the latter on both sides in each case with a strip-like region 19 and, respectively, 21 which, after the battery label 11 has been stuck to the periphery of the battery body 1, is shrunk around the ends of the battery body 1 by means of heat treatment, as FIG. 1 shows.

FIG. 3 shows details of the battery label 11 in the region of the edge to be shrunk on to the flanged-over portion 9 of the battery body and forming the projection 19. The battery label 11 is formed as a composite label having two transparent, stretched and therefore heat-shrinkable plastic film layers 23, 25, in particular of PVC, of which the film layer 23 forms the outermost layer facing away from the battery body 1, and the film layer 25 is located on the inside and carries an adhesive layer 27, for example a contact adhesive layer made of a pressure-sensitive contact adhesive, with which the battery label 11 can be stuck to the entire area of the periphery of the battery body 1 by simply being pressed on. Protected between the two film layers 23, 25, on the inner side of the outer film layer 23, there is a decoration printed on in reverse printing, that is to say mirror-reversed, in the form of a possibly multicolor printing ink layer 29, while the outer side of the film layer 25 located on the inside bears a highly glossy metallization layer 31 in the form of a very thin metal layer, in particular of aluminum, spluttered on or vapor-deposited or applied to the film layer 25 in accordance with other conventional application methods. The outer film layer 23 provided with the printing ink layer 29 and the film layer 25 provided with the metallization layer 31 are connected flatly to each other via a connecting layer 33, here in the form of a laminating adhesive layer. The laminating adhesive layer 33 can also be a laminating varnish layer or a contact adhesive layer. The printing ink layer 29 can alternatively also be printed on the side of the outer film layer 23 facing away from the metallization layer 31.

Along the edge 19 projecting beyond the battery body 1 on the side of the flanged-over portion 9, the metallization 31 is cut out between the peripheral contour edge 35 of the film layers 23, 25 and a marginal edge 37 of the metallization in the layer composite, in a strip-shaped region 39 which extends along the edge 19 of the battery label 11 to be shrunk onto the flanged-over portion 9. The strip-like region can have the width of the projection 19 at the edge, but is preferably narrower than this projection. The laminating adhesive layer 33 extends as far as the strip-like region 39 and fills the latter between the film layers 23, 25. The laminating adhesive layer 33 here forms a sealing strip 41, which protects the marginal edge 37 of the metallization against corrosive substances.

The strip region 39 cut out of the metallization layer 31 can already be cut out during the application of the metallization layer 31 or else can be produced subsequently by removing the metallization. Since the strip-shaped region 39 extends in the longitudinal direction of the web of film material of which the film 25 consists, metallization that has already been applied can be removed without difficulty by means of mechanical methods, such as grinding off, or with the aid of a transfer tape.

It is actually sufficient if the sealing strip 41 is provided only along the edge 19 which comes to lie over the flanged-over portion 9 of the battery body 1. However, the sealing strip 41 can also be provided along the entire peripheral contour of the battery label 11, as indicated in FIG. 2 by a dash-dotted line 41′.

The layer composite of the battery label 11 illustrated in FIG. 3 is to be understood only as an example, albeit a preferred example. A large number of variants are possible. For example, the printing ink layer 29, instead of being provided on the inside of the film layer 23′, can also be provided on its outside, as indicated at 29′. In such a case, the metallization layer 31 can also be provided on the inside of the film layer 23. The layer composite of the battery label 11 can also comprise more than two stretched, heat-shrinkable film layers, for example three film layers, which can be connected to one another, if appropriate over further layers, by connecting layers such as laminating adhesive layers or the like. For example, in the case of a battery label having three film layers, the colored imprint layer can be provided on the outermost film layer or the central film layer, while the metallization layer is applied to the central film layer or the lower film layer placed nearest the battery body.

In the following text, variants of the battery label illustrated in FIG. 3 are to be explained. Identically acting components are designated by the reference numbers from FIG. 3 and provided with a letter to distinguish them. The illustrated layer structure of the variants explained below conforms to the layer structure of the battery label in FIG. 3. In order to explain the structure and the mode of action, reference will be made to the description of FIGS. 1 to 3. To the extent that variants of the layer structure have been explained in connection with FIG. 3, these variants can also be used in the following exemplary embodiments.

In the battery label 11a, not only is the metallization layer 31a cut out in the strip-shaped region 39a, as compared with the peripheral contour 35a of the outer film layer 23a, but also the inner film layer 25a and, if appropriate, although not necessarily, the printing ink layer 29a and the connecting layer 33a. The adhesive layer 27a intended for affixing the battery label 11a to the battery body 1 is led over the marginal edge 37a of the metallization layer 31a as far as the inside of the film layer 23a in the strip-shaped region 39a. The marginal edge 37a is thus protected against corrosion by the adhesive layer 27a. The peripheral contour 35a of the film layer 23a and the peripheral contour of the film layer 25a including the metallization layer 31a are produced in separate punching steps, while the sealing strip 41a formed by the adhesive layer 27a is applied during the application of this layer.

While the battery label 11a, as explained above, can also be constructed with three shrinkable layers, this variant can also manage with a single shrinkable film layer, by the metallization layer being connected directly to the printing ink layer 29a, leaving out the connecting layer, or else being applied to the inside of the film layer 23a if the printing ink layer 29a is printed on to the outside of the film layer 23a. The inner film layer 25a can then be dispensed with or replaced by a barrier layer or the like, possibly printed on.

In the battery label 11b in FIG. 5, all the layers of the layer composite extend as far as the peripheral contour 35b, and can therefore be contoured in a common punching step. The layer structure of the battery label 11b otherwise corresponds to the layer structure of the battery label 11 in FIG. 3 and also permits all the variants mentioned there. The sealing strip 41b runs outside the marginal contour 35b and not only covers the marginal edge 37b of the metallization layer 31b but also overlaps the marginal edges of the film layers 23b and 25b. The sealing strip 41b consists of the material of the connecting layer 33b, such as a laminating adhesive layer or laminating varnish layer, and may be produced most simply by the layer of composite being squeezed close to the marginal contour 35b, as indicated by an arrow 43. If the layer composite is squeezed while the material of the connecting layer 33b is still capable of flow, the emerging connecting layer material of the sealing strip 41b is formed. However, the sealing strip 41b can also be applied in a separate operation.

The battery label 11c in FIG. 6 also has the advantage that the individual layers of its layer composite have a common external contour 35c, that is to say can be contoured in a common punching step. The layer composite structure of the battery label 11c also corresponds to the battery label 11 from FIG. 3, including the variants explained there. The marginal edge 37c of the metallization layer 31c to be protected against corrosion is offset inward toward the marginal contour 35c and is formed by a gap 45 penetrating at least the metallization 31c but here the inner film layer 25c as well. In order to form the sealing strip 41c, the gap 45 is filled with the material, for example laminating adhesive, of the connecting layer 33c adjoining the metallization layer 31c. Although, in this embodiment, the residual strip of the metallization layer 31c that remains between the gap 45 and the marginal contour 35c is not protected against corrosion, the width of this strip can be kept very small in practice, so that any possible corrosion damage on this very narrow strip has only a marginally detrimental effect on the appearance of the battery label. This negligible disadvantage is balanced out by the ability to produce the gap 45 simply, since the gap 45 can be produced without difficulty and also with any desired contour by means of simple punching tools, possibly displacing material. In particular, the battery label 11c can also be produced without difficulty with a sealing strip enclosing the entire peripheral contour of the label.

The gap 45 can be restricted to the metallization layer 31c and does not necessarily have to extend into or through a layer adjoining the metallization layer 31c, here the film layer 25. Provided that the gap 45 reaches as far as the adhesive layer 27c or the printing ink layer 29c, the material of the adhesive layer 27c or of the printing ink layer 29c can be used instead of the material of the connecting layer 33c for the sealing strip 41c.

1. A label in the form of a layer composite, comprising a transparent plastic film layer (23), a covering layer (25; 27) covering the film layer (23) flatly and a metallization layer (31) arranged between the film layer (23) and the covering layer (25; 27) and covering the latter flatly and completely on both its flat sides,
characterized in that the metallization layer (31), at or close to at least one portion of the peripheral edge (35) of the film layer (23) defining the label contour, has a marginal edge (37) which is covered by a sealing strip (41) extending at least over the thickness of the metallization layer (31).

2. The label as claimed in claim 1, characterized in that the covering layer is also formed as a plastic film layer (25).

3. The label as claimed in claim 2, characterized in that the marginal edge (37) of the metallization layer (31) runs along the sealing strip (41) at a distance from the peripheral edge (35) of the two film layers (23,25), and in that a connecting layer (33), in particular a laminating adhesive layer or a laminating varnish layer or contact adhesive layer, is arranged between the two film layers, extending beyond the marginal edge (37) of the metallization layer (31) and forming the sealing strip (41).

4. The label as claimed in claim 2, characterized in that, between the two film layers (23b, 25b) there is arranged a connecting layer (33b), in particular a laminating adhesive layer or a laminating varnish layer or contact adhesive layer, which extends beyond the marginal edges both of the metallization layer (31b) and the two film layers (23b, 25b) and, in order to form the sealing strip (41b), reaches over the marginal edges of the two film layers (23b, 25b).

5. The label as claimed in claim 1 or 2, characterized in that, on the side of the metallization layer (31a) facing away from the (first) film layer (23a), the layer composite comprises an adhesive layer (27a) used to affix the label (11a) to an object (1), in that the marginal edge (37a) of the metallization layer (31a) and, if present, the marginal edge of each further layer arranged between the metallization layer (31a) and the adhesive layer (27a) in the layer structure, in particular of a second plastic film layer (25a), run at a distance from the peripheral edge (35a) of the first film layer (23a), and in that the adhesive layer (27a) extends beyond the marginal edge of the metallization layer (31a) and, if appropriate, the further layer and forms the sealing strip (41a).

6. The label as claimed in claim 1, characterized in that the metallization layer (31c) at a distance from the peripheral edge (35c) of the film layer (23c) defining the label contour has a gap (45) which forms the marginal edge (37c) to be sealed, which is sealed with the sealing strip (41c).

7. The label as claimed in claim 6, characterized in that the gap (45) is formed by a large number of non-cohering regions of the metallization layer.

8. The label as claimed in claim 6 or 7, characterized in that the sealing strip (41c) is part of a printing ink layer or of a connecting layer (33c) or of an adhesive layer intended to affix the label to an object (1).

9. The label as claimed in claim 6, characterized in that the covering layer is formed as a plastic film layer (25c).

10. The label as claimed in claim 9, characterized in that the gap (45) extends through the metallization layer (31c) and at least partly into one (25c) of the two film layers.

11. The label as claimed in claim 10, characterized in that the gap (45) extends completely through this one film layer (25c), in particular the second film layer.

12. The label as claimed in claim 6, characterized in that the gap (45) is formed as a punch cut, in particular a punch cut that displaces material, or is engraved into the metallization layer or is produced by removing the metallization layer by means of microwave energy or corona discharge or fluid or solid particle jet treatment or brush treatment or etching.

13. The label as claimed claim 1, characterized in that the sealing strip (41) extends substantially along the entire peripheral edge of the label (11).

14. The label as claimed in claim 1, characterized in that, in the layer composite between the film layer (23) and the metallization layer (31) or on the side of the transparent plastic film layer (23) facing away from the metallization layer (31), there is arranged a printing ink layer (29) forming a decorative imprint.

15. The label as claimed in claim 1, characterized in that it is formed as an adhesive label, the metallization layer (31) being arranged in the layer composite between the transparent plastic film layer (23) and an adhesive layer (27), in particular a contact adhesive layer, used to affix the label to an object (1).

16. The label as claimed in claim 15, characterized in that at least the plastic film layer (23) forming the outermost layer of the label (11) and facing away from the adhesive layer (27), preferably each plastic film layer of the label (11), is formed as a stretched plastic film layer that can be shrunk back when heated, and in that the label (11) is formed as a battery label which is intended to encase the peripheral surface of a substantially cylindrical body (1) of a dry battery and, with its edges {19, 21) projecting axially beyond the body (11) of the dry battery, can be shrunk onto the end faces of the latter.

17. The label as claimed in claim 16, characterized in that the plastic film layer (23) is stretched in a direction which, as referred to the battery body (1), runs in its peripheral direction, and in that the sealing strip (41) extends at least along a portion of the peripheral edge of the label (11) that extends in the stretching direction.
